(19) United States
(12) Patent Application Publication
(10) Pub. No.: US 2025/0337832 A1
(43) Pub. Date: Oct. 30, 2025

(54) UNINTENDED PHONE CALL PREVENTION IN MOTOR VEHICLE

(71) Applicant: FORD GLOBAL TECHNOLOGIES, LLC, DEARBORN, MI (US)

(72) Inventors: Brendan Diamond, Grosse Pointe, MI (US); Andrew Brown, Royal Oak, MI (US); John R. Van Wiemeersch, Novi, MI (US); Keith Weston, Canton, MI (US); Stuart C. Salter, White Lake, MI (US)

(21) Appl. No.: 18/650,573

(22) Filed: Apr. 30, 2024

(51) Int. Cl. H04M 1/72463; H04M 1/72409; H04M 1/72412; H04M 1/72454; H04W 12/02

(52) U.S. Cl. CPC H04M 1/724631; H04M 1/724098; H04M 1/72412; H04M 1/72454; H04W 12/02; H04M 2201/38

(57) ABSTRACT

A mobile telephone carried by a user pairs with a wireless interface in a transportation vehicle in order to coordinate operation of the mobile telephone, including exchange of audio signals and remote call control via the wireless interface. Once paired, positions of the mobile telephone and the user are monitored using a tracking sensor. An existing call state of the mobile telephone is determined via the wireless interface from a plurality of call states including a dialing-request state and a call-in-progress state. Whether or not the mobile telephone is in an engagement relation with the user is determined in response to the positions of the mobile telephone and the user and/or the exchange of audio signals. The dialing-request state is canceled when the dialing-request state is initiated not using the remote call control at a time when the user is not in the engagement relation with the mobile telephone.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to prevention of the dialing of unintended mobile telephone calls, and, more specifically, to vehicular control of a mobile telephone.

Mobile telephone users generate calls unintentionally and sometimes unknowingly while their mobile telephone is in their pocket, purse, or other carrying location (often referred to as Pocket Dialing). Such calls are much more disruptive than normal calls and can sometimes lead to an invasion of privacy as the person who made the call does not know that someone may be listening or that they are being recorded onto someone's voicemail. When a user is within or approaches their motor vehicle, their mobile telephone may make a local wireless connection to the electronics in the vehicle to enable handsfree conversation and control using the vehicle as an extension of the phone. If a user is unaware of a pocket-dialed call and the phone is paired with the vehicle electronics then the loss of privacy may be even greater.

### SUMMARY OF THE INVENTION

In one aspect of the invention, a transportation vehicle is adapted to interact with a mobile telephone carried by a user of the transportation vehicle. The vehicle has a wireless interface configured to pair with the mobile telephone and at least one tracking sensor configured to monitor the positions of the mobile telephone and the user. A controller is coupled to the wireless interface so that the controller is communicatively coupled to the mobile telephone, wherein the controller is configured to coordinate operation of the mobile telephone including exchange of audio signals and remote call control. The controller is configured to (1) determine an existing call state of the mobile telephone via the wireless interface from a plurality of call states including a dialing-request state and a call-in-progress state, (2) determine whether the mobile telephone is in an engagement relation with the user in response to the positions of the mobile telephone and the user or the exchange of audio signals, and (3) cancel the dialing-request state when the dialing-request state is initiated not using the remote call control at a time when the user is not in the engagement relation with the mobile telephone.

### BRIEF DESCRIPTION OF THE DRAWINGS

FIG. 1 is a schematic diagram showing a user carrying a mobile telephone approaching a vehicle.

FIG. 2 is a schematic diagram showing a mobile telephone in a vehicle interior.

FIG. 3 is a schematic block diagram showing a user with a mobile telephone within a vehicle together with a cellular telephone system for completing calls to a remote telephone.

FIG. 4 is a block diagram showing details of a controller according to an embodiment of the invention.

FIG. 5 is a flowchart showing a method of deactivating or blocking unintended calls.

FIG. 6 is a flowchart showing a method of informing a remote telephone user of a situation of the user when an unintended call which reached the remote telephone is disconnected.

### DETAILED DESCRIPTION OF PREFERRED EMBODIMENTS

In some embodiments, monitoring of a state of a mobile wireless device (e.g., mobile telephone) begins when the device approaches and pairs with a vehicle. For example, a wireless interface (e.g., a transceiver configured for cellular, Wi-Fi, Bluetooth®, Bluetooth® Low Energy (BLE), Ultra-Wideband (UWB), Near Field Communication (NFC), or other communication modes) may determine that a user and/or the user's telephone are near the vehicle as a result of pairing with the mobile telephone. The mobile telephone may be comprised of a smartphone executing a telephone-as-a-Key (PaaK) application, for example. Based on a location and state of the mobile telephone, a vehicle controller determines whether an existing call or the dialing of a new call may be unintentional. An unintentional call may be terminated by the vehicle controller. For example, when the vehicle controller determines that a call is initiated while the user is in the vehicle, that the telephone is not in the user's hands, and that the call is not initiated using the vehicle as a handsfree interface, then the call is unintended and should not be dialed (or allowed to continue if already connected). An interior camera sensor suite may provide monitoring of the user and the mobile telephone to track their placement/movements in order to classify the user's engagement relation with the mobile telephone (i.e., whether the user is consciously interacting with the telephone). If a call or dialing attempt is canceled, then the vehicle may inform the user that a pocket dial was detected and was terminated.

An unintended call can also be detected based on audio content of a completed call, including the behavior of either party to the call. The vehicle controller or the mobile telephone can perform audio processing (especially of the initial part of the call) and if no conversation is being spoken (e.g., only noise is detected or repeated words or queries are detected) then the telephone call can be ended. For example, if the person on the other end of the call utters key phrases (such as a repeated “Hello” or “are you there?” or “is this a pocket-dial”), an alert can pop-up on the vehicle display screen and the call ended. The displayed message could state [You may have accidently dialed (insert number or contact name)—the call was ended for your convenience]. Alternatively, a call taking place using only the mobile telephone microphone/speaker could be switched to a vehicle handsfree mode and an announcement made to the user that [You may have accidently dialed (insert number or contact name) and the call is still open. Please end the call if this was made in error]. When switched to handsfree mode, a ring sound could be generated even though the call is open and the telephone is set to silent mode.

The mobile telephone may become linked to the vehicle (e.g., via Bluetooth®) while the user is outside/approaching the vehicle. If the telephone is in an on-going call state but aspects of the call behavior indicates lack of engagement (e.g., the user is not responding the telephone call audio, or does not have the telephone in their hands and is not wearing headphones or ear buds) then the vehicle may terminate the call. Alternatively, the vehicle controller may initiate haptic feedback to the user via an alert to the telephone or may display an icon, alert message, or audio feedback via a human machine interface of the vehicle.

Close contacts who may have been the recipient of an unintended call that went as far as ringing through could be concerned about the user when they are pocket dialed. On an opt-in basis for preselected telephone contacts, after the pocket dialed call is terminated a message can be automatically shared by the vehicle controller with the close contact. The message can include text and/or pictures and video (from interior cameras showing vehicle occupants or exterior cameras showing vehicle surroundings) so that the pocket dial recipient could potentially see that the user is not in distress. An audio announcement or displayed message could be provided to the user to inform them when this occurs.

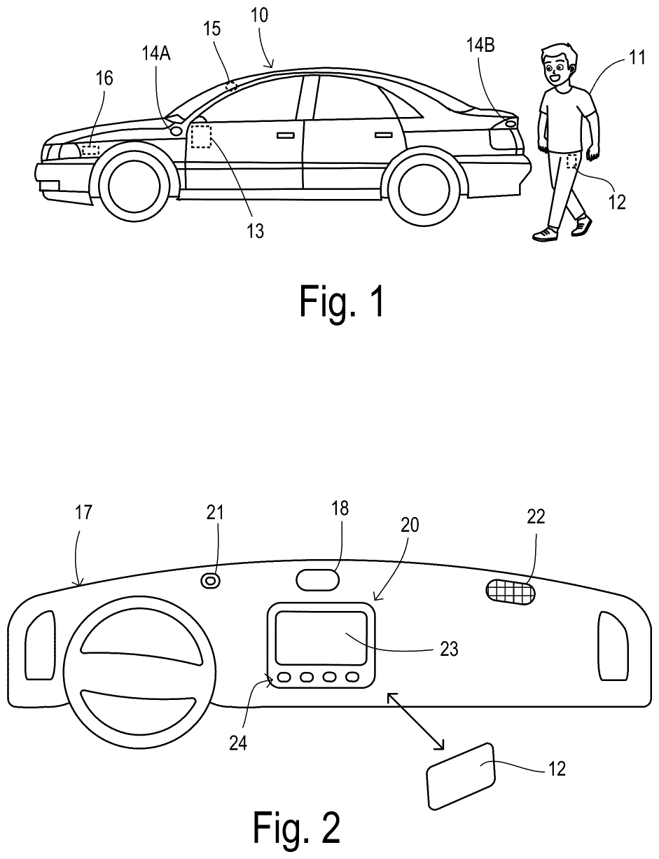

FIG. 1 shows a transportation vehicle 10 with a nearby user 11 who carries a mobile wireless device (e.g., mobile telephone or smartphone) 12. Vehicle 10 includes a wireless interface 13 which can pair with mobile telephone 12 using a wireless service such as Bluetooth®, BLE, UWB, Wi-Fi, or NFC. Vehicle 10 includes a suite of sensors for monitoring user 11 and mobile telephone 12. The suite of tracking sensors may include exterior cameras (image sensors) 14A and 14B, interior camera 15, and an acoustic sensor (microphone) 16. The tracking sensors are adapted to monitor the positions, orientations, and/or movements of user 11 and mobile telephone 12 to evaluate an engagement relation of user 11 with telephone 12 (i.e., whether user 11 is actively manipulating the telephone).

FIG. 2 shows an instrument panel 17 in an interior passenger compartment of vehicle 10. A tracking/monitoring sensor 18 on instrument panel 17 may be an image sensor, ultrasonic sensor, or other device that enables tracking and classification of objects including mobile telephone 12 and user 11. Instrument panel 17 also supports a human machine interface comprised of a display panel 20, interior microphone 21, and interior loudspeaker 22. Display panel 20 includes a touchscreen display 23 and hardware inputs (e.g., switches) 24, each acting as input elements for receiving user responses and control signals as known in the art. Handsfree operation of mobile telephone 12 is available to user 11 when seated in the passenger compartment as result of the pairing of telephone 12 with the wireless interface of the vehicle. Handsfree operation includes (1) controlling operation of telephone 12 (e.g., answering, dialing, and call termination) using touchscreen 23, input switches 24, and microphone 21 for receiving spoken commands, and (2) transfer of audio signals to utilize microphone 21 and loudspeaker 22 for the call audio.

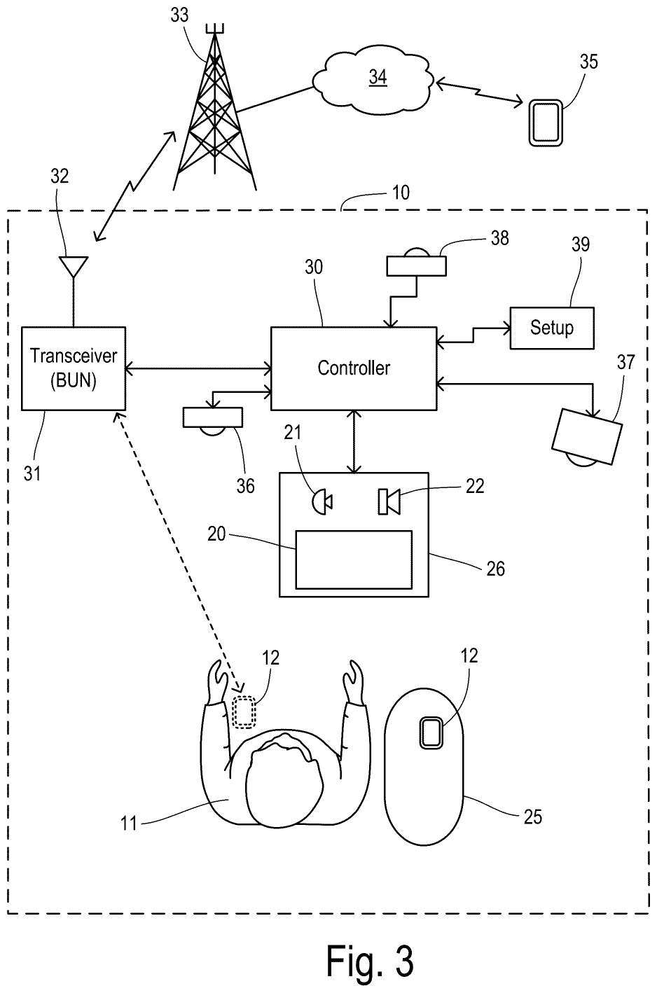

FIG. 3 shows vehicle 10 in greater detail. User 11 is seated within vehicle 10 together with their mobile telephone 12. At times, user 11 may in an engagement relation by holding mobile telephone 12 in their hands. As shown in FIG. 3, however, mobile telephone 12 is in a “tote location” not associated with being in an engagement relation with user 11. The tote location may be comprised of a garment pocket or a carrying bag or purse, for example. More specifically, dashed lines show mobile telephone 12 in a pants pocket of user 11 and solid lines show mobile telephone 12 stowed on a console shelf 25. In the tote location, any activation of the dialing of a call on mobile telephone 12 is likely to be an unintended call.

A human machine interface 26 (HMI, including touchscreen display 20, microphone 21, loudspeaker 22) is accessible to user 11 and is coupled to a vehicle controller 30 (e.g., an electronic module with a programmable, general purpose microprocessor). A wireless interface comprised of a wireless transceiver 31 is coupled to controller 30 and antennas 32. Transceiver 31 is adapted to pair with mobile telephone 12, and may be comprised of a BUN (BLE, UWB, and NFC) transceiver commonly used in transportation vehicles which may also have Wi-Fi capability. A cellular system 33 is communicatively coupled with mobile telephone 12 and with a telephone network 34 to enable telephone calls between mobile telephone 12 and a remote telephone 35 (which may also be a wireless smartphone). Transceiver 31 may also include a cellular transceiver for providing independent access to cellular voice and data services for vehicle controller 30.

Controller 30 is coupled to a plurality of tracking sensors including interior-looking cameras 36 and 37 and an exterior-looking camera 38. A read/write memory 39 is coupled to controller 30 for storing setup information such as a predetermined list of user contacts and their associated remote telephone numbers for which the user desired to share situational data when a pocket-dialed call is disconnected. Controller 30 may contain a setup routine utilizing HMI 26 for allowing user 11 to preselect the contacts to receive such situational data.

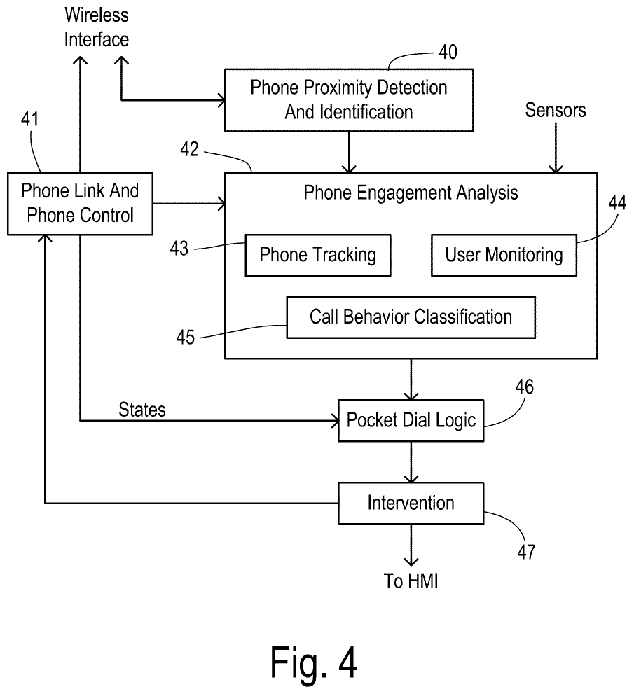

FIG. 4 shows functional elements of controller 30 in greater detail wherein a phone proximity detection and identification block 40 is coupled to the vehicle's wireless interface (e.g., BUN transceiver). When a mobile telephone pairs with controller 30, a phone link and phone control block 41 becomes coupled with the mobile telephone so that it is able to determine various operating states of the mobile telephone and to coordinate/control telephone actions. A phone engagement analysis block 42 is coupled to vehicle sensors which monitor positions of the mobile telephone and the user (e.g., relative positioning and/or absolute positions in or on “tote locations” where the telephone could be stowed, such as a pocket, purse, or console). Analysis block 42 is coupled to phone control block 41 and phone proximity identification block 40 to support various functions of analysis block 42, including a phone tracking block 43, a user monitoring block 44, and a call behavior classification block 45. “Phone engagement” as used herein refers to a relation between the user and the mobile telephone device based on a determination regarding whether or not the user is directing sufficient attention to the mobile telephone that it would be likely the dialed or existing call was intentional. Some spatial relationships may be indicative that such a level of attention could not be present (i.e., would indicate a pocket dial) such as when the telephone is in a garment pocket, carrying bag, or purse. Phone engagement may also be determined based on the content of call audio which is received from phone link 41. As a result of the telephone engagement tracking and user monitoring, call behavior classification block 45 generates an indication to a pocket dial logic block 46 to identify whether or not the user is in the engagement relation with the mobile telephone. Pocket dial logic block 46 receives phone call states from phone control block 41. There may a plurality of different call states including a dialing-request state and a call-in-progress state which are reported to pocket dial logic block 46. In response to a dialing-request state which occurs after the phone mobile telephone becomes paired with the wireless interface, pocket dial logic block 46 checks for the engagement relation and then intervenes in the call process using an intervention block 47. In some embodiments, intervention block 47 cancels any dialing-request state in which both of the following are true: (1) the dialing request is initiated in a manner other than the vehicle interface (i.e., not using the remote call control function provided by the vehicle HMI) and (2) the user is not in the engagement relationship. Cancellation of a dialed call is performed by intervention block 47 by relaying a corresponding control signal via phone control 41 to terminate the dialing operation. In the event that a call has already been connected to a called party, or in the event that the pocket dial logic initiated immediately upon the pairing of the telephone with the wireless interface because a call was already in progress, then the action by intervention block 47 includes a command via phone control block 41 to terminate the mobile telephone call. Additionally, intervention block 47 may send signals via the vehicle HMI to generate messages to the user whenever the dialing-request state is canceled or the call-in-progress state is terminated.

In some embodiments, pocket dial logic block 46 and intervention block 47 may utilize prompting messages in order to elicit a response from the user before taking the intervention. Thus, the termination of a dialing operation or of an existing call may be conditioned according to whether the user indicates that the call is intentional.

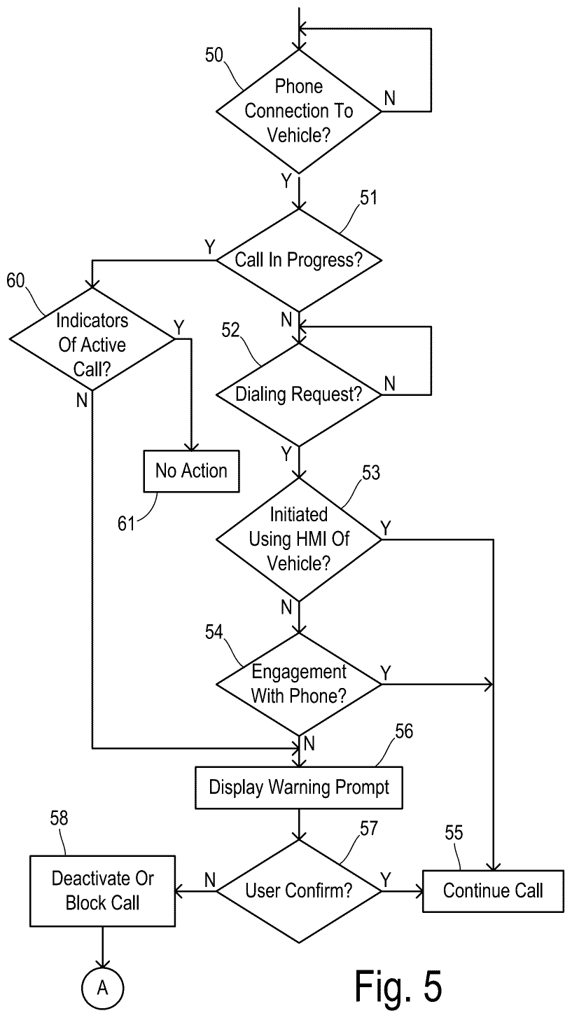

FIG. 5 shows one preferred method of the invention that is executed when a user's mobile telephone connects (pairs) with the vehicle. A check is performed in step 50 to determine whether a telephone connection is present. Once a telephone is connected, then a check is performed in step 51 to determine whether a call is already in progress. If not, then the invention repeatedly checks for dialing requests in step 52. Once a dialing request is detected, then a check is performed in step 53 to determine whether the dialing request was initiated using the interface of the vehicle (i.e., using the touchscreen or spoken commands within the vehicle). If initiated using the vehicle HMI, then the call is allowed to continue in step 55. Otherwise, a check is performed in step 54 to determine whether the user is in an engagement relation with the mobile telephone. If the engagement relation exists, then the call is allowed to continue in step 55. If not, then the vehicle HMI may display a warning prompt to the user in step 56 requesting confirmation of whether a call is intended. A check is performed in step 57 to determine whether the user confirmed that the dialing request is valid. If so, then the call continues in step 55. Otherwise, the dialing request is blocked/canceled, or the ongoing call block is deactivated in step 58.

Returning to step 51, if the mobile telephone is in a call-in-progress state at the time that the user approaches the vehicle for pairing then indicators of an active call are checked in step 60. For example, the audio contents of an open audio channel of the phone call may be monitored, and the audio may be classified according to whether the content of the speech is consistent with or not consistent with characteristics of ongoing or recorded vocalizations such as person-to-person conversations (e.g., interspersed audio from both sides of the call versus silence on one side of the call and utterance of key phrases on the other side such as “hello”). If there are indicators of an active call then no action is taken at step 61. On the other hand, if indicators of an active call are not present (or indicators of a pocket dialing are present) then the method continues at step 56 to display a warning prompt.

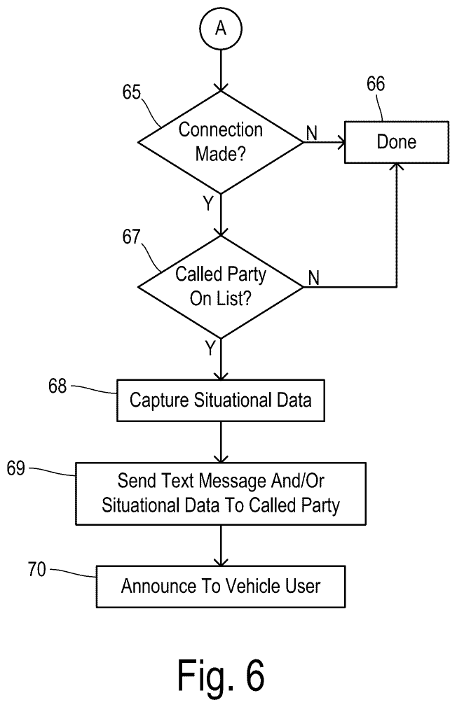

FIG. 6 shows a further method of the invention in which the recipient of a terminated pocket dial call may be updated regarding the situation existing at the vehicle. The method in FIG. 6 may continue immediately after step 58 in FIG. 5 via connection point A. In step 65, a check is performed to determine whether a call connection was actually made (such that a ringing was potentially received by the recipient prior to deactivating the call). If not, then the method completes at step 66. If the recipient telephone did receive the call in step 65 then a check is performed in step 67 to determine whether the recipient is on a preselected “called party” list (e.g., listing close contacts such as family members). If not, then the method completes at step 66. Otherwise, situational data may be captured in step 68 wherein camera images inside and outside the vehicle may be obtained to show the user and any others in the vicinity. In step 69, a text message is sent to the recipient phone number indicating that the call was terminated automatically as a pocket dial call. The message may include situational data for review by the called party. In step 70, an announcement is made in the vehicle to the user to inform about the canceled call and the sending of a subsequent follow-up message to the called party.

What is claimed is:

1. A transportation vehicle adapted to interact with a mobile telephone carried by a user of the transportation vehicle, comprising:
a wireless interface configured to pair with the mobile telephone;
at least one tracking sensor configured to monitor respective positions of the mobile telephone and the user; and
a controller coupled to the wireless interface so that the controller is communicatively coupled to the mobile telephone, wherein the controller is configured to coordinate operation of the mobile telephone including exchange of audio signals and remote call control;
wherein the controller is configured to:
determine an existing call state of the mobile telephone via the wireless interface from a plurality of call states including a dialing-request state and a call-in-progress state;
determine whether the mobile telephone is in an engagement relation with the user in response to the positions of the mobile telephone and the user or the exchange of audio signals; and
cancel the dialing-request state when the dialing-request state is initiated not using the remote call control at a time when the user is not in the engagement relation with the mobile telephone.

2. The transportation vehicle of claim 1 wherein the engagement relation is found to exist when the user holds the mobile telephone, and wherein the engagement relation is found not to exist when the mobile telephone is stowed in a tote location.

3. The transportation vehicle of claim 2 wherein the tote location is comprised of a garment pocket or a carrying bag or purse.

4. The transportation vehicle of claim 1 wherein the engagement relation is found not to exist when the audio signals indicate a user behavior inconsistent with a conversation.

5. The transportation vehicle of claim 1 wherein the controller is further configured to generate a message to the user when the dialing-request state is canceled, wherein the message indicates that the dialing-request state was canceled.

6. The transportation vehicle of claim 5 further comprising a human machine interface having a display panel to display the message.

7. The transport vehicle of claim 1 wherein the controller is further configured to cancel the call-in-progress state when the mobile telephone pairs with the wireless interface already in the call-in-progress state and the user is not in the engagement relation with the mobile telephone.

8. The transportation vehicle of claim 1 further comprising a human machine interface having an input element for receiving a user response, and wherein the controller is further configured to:
display an alert message when the dialing-request state was initiated not using the remote call control at a time when the user is not in the engagement relation with the mobile telephone;
detect the user response; and
forego canceling the dialing-request state when the user response indicates that a telephone call is desired.

9. The transportation vehicle of claim 1 wherein the tracking sensor is comprised of a camera, and wherein the controller is further configured so that after canceling an existing call state the controller:
collects situational data from the camera;
determines whether a remote telephone number associated with the canceled call state is on a predetermined list of user contacts; and
forwards the collected situational data to the remote telephone number with a message indicating that the call state was automatically canceled.

10. The transportation vehicle of claim 9 further comprising a human machine interface having an input element for receiving a user response, and wherein the controller is further configured to:
compile the predetermined list of user contacts in response to the user response via the input element.

11. A method of operating a mobile telephone carried by a user coupled to a transportation vehicle, comprising the steps of:
pairing the mobile telephone with a wireless interface in the transportation vehicle in order to coordinate operation of the mobile telephone including exchange of audio signals and remote call control via the wireless interface;
monitoring positions of the mobile telephone and the user using at least one tracking sensor;
determining an existing call state of the mobile telephone via the wireless interface from a plurality of call states including a dialing-request state and a call-in-progress state;
determining whether the mobile telephone is in an engagement relation with the user in response to the positions of the mobile telephone and the user or the exchange of audio signals; and
canceling the dialing-request state when the dialing-request state is initiated not using the remote call control at a time when the user is not in the engagement relation with the mobile telephone.

12. The method of claim 11 wherein the engagement relation is found to exist when the user holds the mobile telephone, and wherein the engagement relation is found not to exist when the mobile telephone is stowed in a tote location.

13. The method of claim 12 wherein the tote location is comprised of a garment pocket or a carrying bag or purse.

14. The method of claim 11 wherein the engagement relation is found not to exist when the audio signals indicate a user behavior inconsistent with a conversation.

15. The method of claim 11 further comprising the step of generating a message to the user when the dialing-request state is canceled, wherein the message indicates that the dialing-request state was canceled.

16. The method of claim 15 wherein the message is displayed on a human machine interface having a display panel.

17. The method of claim 11 further comprising the step of canceling the call-in-progress state when the mobile telephone pairs with the wireless interface already in the call-in-progress state and the user is not in the engagement relation with the mobile telephone.

18. The method of claim 11 wherein the transportation vehicle includes a human machine interface having an input element for receiving a user response, and wherein the method further comprises the steps of:
displaying an alert message when the dialing-request state was initiated not using the remote call control at a time when the user is not in the engagement relation with the mobile telephone;
detecting the user response; and
foregoing canceling the dialing-request state when the user response indicates that a telephone call is desired.

19. The method of claim 11 wherein the tracking sensor is comprised of a camera, and wherein the method further comprises the steps, after canceling an existing call state, of:
collecting situational data from the camera;
determining whether a remote telephone number associated with the canceled call state is on a predetermined list of user contacts; and
forwarding the collected situational data to the remote telephone number with a message indicating that the call state was automatically canceled.

20. The method of claim 19 wherein the transportation vehicle includes a human machine interface having an input element for receiving a user response, and wherein the method further comprises the step of compiling the predetermined list of user contacts in response to the user response via the input element.
